(19) United States
(12) Patent Application Publication
(10) Pub. No.: US 2024/0340837 A1
(43) Pub. Date: Oct. 10, 2024

(54) APPARATUS AND METHOD FOR MANAGING CONTEXT ASSOCIATED WITH A UE DURING DISCONTINUOUS COVERAGE SCENARIO IN A WIRELESS COMMUNICATION SYSTEM

(71) Applicant: SAMSUNG ELECTRONICS CO., LTD., Suwon-si (KR)

(72) Inventors: Lalith KUMAR, Bangalore (IN); Aman AGARWAL, Bangalore (IN); Sidhant JAIN, Bangalore (IN); Mahmoud WATFA, Staines, Middlesex (GB)

(21) Appl. No.: 18/627,387

(22) Filed: Apr. 4, 2024

(30) Foreign Application Priority Data
Apr. 7, 2023 (IN) 202341026259
Apr. 14, 2023 (IN) 202341027712
Mar. 22, 2024 (IN) 202341026259

(51) Int. Cl. H04W 60/06; H04W 48/16

(52) U.S. Cl. CPC H04W 60/06; H04W 48/16

(57) ABSTRACT

The disclosure relates to a 5G or 6G communication system for supporting a higher data transmission rate. Specifically, the disclosure provides a method for managing a context associated with a UE during a discontinuous coverage scenario in a telecommunication network by a network apparatus. The method includes detecting a 5G mobile management (5GMM) signalling congestion to perform a NAS level congestion control. The method includes receiving unavailability information due to discontinuous coverage, when the UE is allowed to initiate a 5GMM procedure. Further, the method includes avoiding to reject a request for mobility registration update from the UE to manage a context associated with the UE during a discontinuous coverage scenario, when the network apparatus receives the unavailability information due to discontinuous coverage from the UE.

This application is based on and derives the benefit of Indian Partial Application 202341026259 filed on Apr. 7, 2023, Indian Partial Application 202341027712 filed on Apr. 14, 2023, and Indian Complete Application 202341026259 filed on Mar. 22, 2024, the contents of which are incorporated herein by reference. The embodiments disclosed herein generally relates to a telecommunication network, and more particularly, to a system and method for handling paging proceed flag (PPF) flag and mobility management back-off timer (MM BO) timer for discontinuous coverage in the telecommunication network.

### BACKGROUND

### 1. Field

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

### 2. Description of Related Art

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated access and Backhaul) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and Software-Defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure relates to wireless communication systems and, more specifically, the present disclosure relates to a method for managing a context associated with a UE during a discontinuous coverage scenario in a wireless communication system. The method includes detecting, by a network apparatus, a 5G mobile management (5GMM) signalling congestion to perform a NAS level congestion control. Further, the method includes receiving, by the network apparatus, unavailability information due to discontinuous coverage, when the UE is allowed to initiate a 5GMM procedure. Further, the method includes avoiding to reject, by the network apparatus, a request for mobility registration update from the UE to manage a context associated with the UE during a discontinuous coverage scenario, when the network apparatus receives the unavailability information due to discontinuous coverage from the UE.

In an embodiment, the timer is a mobility management back-off (MM BO) timer i.e., the timer T3346 timer.

In an embodiment, the unavailability information is at least one of: a start of unavailability period, an unavailability period duration and an unavailability type.

In an embodiment, the unavailability type is set to unavailability due to the discontinuous coverage.

In an embodiment, the UE is allowed to initiate a 5GMM procedure even if a timer is running to indicate unavailability information.

In an embodiment, the network apparatus accepts a NAS signaling message and a mobility registration update wherein at least one of: the NAS signaling message and the mobility registration update comprises unavailability information due to discontinuous coverage.

In an embodiment, the network apparatus is at least one of an AMF entity and an MME entity.

In an embodiment, the unavailability information is sent in at least one of: a registration request procedure, a tracking area update, a mobility registration update procedure, and a service request procedure.

Embodiments disclosed herein provide a network apparatus for managing a context associated with a UE during a discontinuous coverage scenario in a telecommunication network. The network apparatus includes a UE context managing controller coupled with a memory and a processor. The UE context managing controller is configured to detect a 5GMM signalling congestion to perform a NAS level congestion control. The UE context managing controller is configured to receive unavailability information due to discontinuous coverage, when the UE is allowed to initiate a 5GMM procedure. The UE context managing controller is configured to avoid to reject a request for mobility registration update from the UE to manage a context associated with the UE during a discontinuous coverage scenario, when the network apparatus receives the unavailability information due to the discontinuous coverage from the UE.

Embodiments disclosed herein provide a method for managing a context associated with the UE during a discontinuous coverage scenario in a telecommunication network. The method includes receiving, by a network apparatus, a mobility registration update including new unavailability information from the UE, when the UE is registered with the AMF entity. Further, the method includes receiving, by the network apparatus, a mobility registration update message when the UE determines that the UE condition is changed. Further, the method includes determining, by the network apparatus, whether the mobility registration update message comprises the new unavailability information. In an embodiment, further, the method includes updating a UE context with new unavailability information upon determining that the mobility registration update message comprises the new unavailability information. In another embodiment, further, the method includes deleting the unavailability information from the UE context upon determining that the mobility registration update message does not comprise the new unavailability information.

Embodiments disclosed herein provide a network apparatus for managing a context associated with the UE during a discontinuous coverage scenario in a telecommunication network. The network apparatus includes a UE context managing controller coupled with a memory and a processor. The UE context managing controller is configured to receive a mobility registration update including a new unavailability information from a UE, when the UE is registered with the AMF entity. Further, the UE context managing controller is configured to receive a mobility registration update message when the UE determines that the UE condition is changed. Further, the UE context managing controller is configured to determine whether the mobility registration update message comprises the new unavailability information. In an embodiment, the UE context managing controller is configured to update a UE context with new unavailability information upon determining that the mobility registration update message comprises the new unavailability information. In another embodiment, the UE context managing controller is configured to delete the unavailability information from the UE context upon determining that the mobility registration update message does not comprise the new unavailability information.

Embodiments disclosed herein, the UE triggers mobility registration update procedure to inform unavailability information, when the UE determines change in the unavailability information.

Embodiments disclosed herein, the UE includes unavailability information each time the UE triggers mobility registration update procedure in response to determining that UE has set the unavailability information in the network and it's still applicable.

Embodiments disclosed herein the UE does not include unavailability information and triggers mobility registration update procedure when the UE wants to delete the stored unavailability information at the network apparatus.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The provided method and the telecommunication network are illustrated in the accompanying drawings, throughout which like reference letters indicate corresponding parts in the various figures. The embodiments herein will be better understood from the following description with reference to the drawings, in which:

FIG. 1 illustrates a scenario of handling PPF flag and MM BO timer for discontinuous coverage in accordance with some embodiments of the present disclosure;

FIG. 2 illustrates a scenario, where the AMF entity/network behaviour when any subsequent mobility registration update or any other NAS procedure with or without start time and unavailability period information is received is also not defined in the existing solutions in accordance with some embodiments of the present disclosure;

FIG. 3 illustrates a scenario of handling PPF flag and MM BO timer for discontinuous coverage in accordance with some embodiments of the present disclosure;

FIG. 4 illustrates an example scenario, wherein the UE indicates a Start time as 10:00 UTC in registration request message to the AMF entity according to embodiments of the present disclosure;

FIG. 5 illustrates an example scenario, wherein the UE mandatorily includes the start time in every registration procedure, and the AMF entity removes the start time, if it does not receive the start time in accordance with some embodiments of the present disclosure;

FIG. 6 illustrates an example scenario, wherein the UE will not indicate in subsequent registration procedure, the AMF entity continues to use the old received value, unless explicitly indicated by the UE (if the start time has to be removed) in accordance with some embodiments of the present disclosure;

FIG. 7 illustrates various hardware components of a network apparatus in accordance with some embodiments of the present disclosure;

FIG. 8 illustrates a flowchart of a method, implemented by the UE, for managing the context associated with the UE during the discontinuous coverage scenario in the telecommunication network in accordance with some embodiments of the present disclosure;

FIG. 9 illustrates a flowchart of a method, implemented by the UE, for managing the context associated with the UE during the discontinuous coverage scenario in the telecommunication network in accordance with some embodiments of the present disclosure;

FIG. 10 illustrates a terminal (or a user equipment (UE) according to embodiments of the present disclosure; and

FIG. 11 illustrates a base station according to embodiments of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the present disclosure.

### DETAILED DESCRIPTION

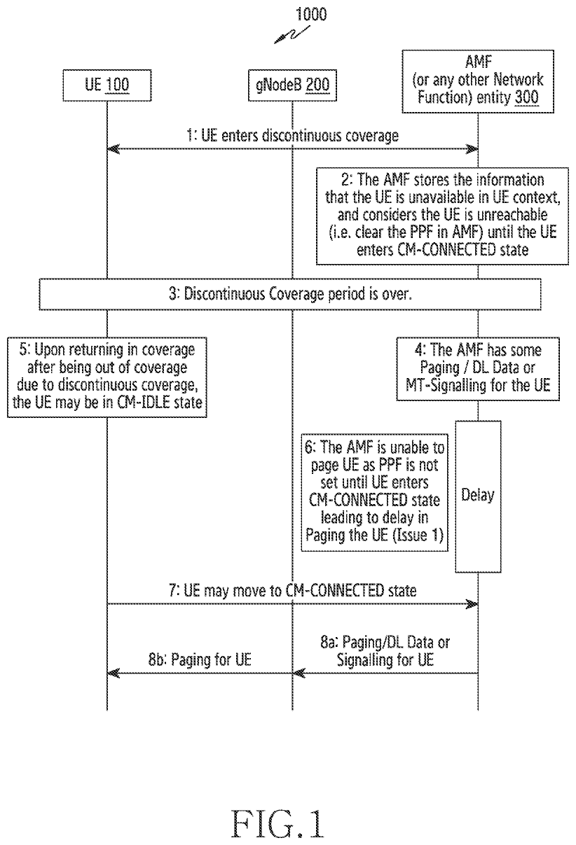

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Definitions of some of the terms used in the patent disclosure are as follows:

| | | |
|---|---|---|
| 1. | 3GPP | Third Generation Partnership Project |
| 2. | 5GC | 5G Core |
| 3. | 5GMM | 5G Mobility Management |
| 4. | 5GS | 5G System |
| 5. | AMF | entity Access and Mobility Management Function |
| 6. | AS | Access Stratum |
| 7. | CAG | Closed access group |
| 8. | CAG ID | Closed Access Group Identifier |
| 9. | DC | Discontinuous Coverage |
| 10. | DisCo | Discontinuous Coverage |
| 11. | DL | Downlink |
| 12. | eDRX | Extended Discontinuous Reception |
| 13. | EHPLMN | Equivalent Home Public Land Mobile Network |
| 14. | EMM | EUTRA Mobility Management |
| 15. | eNB | Evolved Node-B |
| 16. | gNB | Next generation Node-B |
| 17. | EPLMN | Equivalent Public Land Mobile Network |
| 18. | EPS | Evolved Packet System |
| 19. | eSIM | embedded Subscriber Identity Module |
| 20. | E-UTRA | Evolved Universal Mobile Telecommunication Access |
| 21. | EUTRAN | Evolved Universal Mobile Telecommunication Access Network |
| 22. | FPLMN | Forbidden Public Land Mobile Network |
| 23. | GEO | Geostationary Orbit |
| 24. | GPRS | General Packet Radio Service |
| 25. | GPS | Global Positioning System |
| 26. | GSM | Global System for Mobile Communication |
| 27. | HPLMN | Home Public Land Mobile Network |
| 28. | MCC | Mobile Country Code |
| 29. | ME | Mobile Equipment |
| 30. | MEO | Medium Earth Orbit |
| 31. | MICO | Mobile Initiated Communication Only |
| 32. | MME | Mobility Management Entity |
| 33. | MNC | Mobile Network Code |
| 34. | MO | Mobile Originating |
| 35. | MS | Mobile Station. The present document makes no distinction between MS and UE. |
| 36. | MT | Mobile Terminating |
| 37. | NAS | Non-Access Stratum |
| 38. | NG-RAN | Next Generation Radio Access Network |
| 39. | NR | New Radio |
| 40. | NTN | Non Terrestrial Networks |
| 41. | NW | Network |
| 42. | OOS | Out of Service |
| 43. | PDN | Packet Data Network |
| 44. | PDU | Packet Data Unit |
| 45. | PLMN ID | Public Land Mobile Network Identity |
| 46. | PPF | Paging Proceed Flag |
| 47. | RPLMN | Registered Public Land Mobile Network |
| 48. | RRC | Radio Resource Control |
| 49. | RU | Registration Update |
| 50. | SAT | Satellite |
| 51. | SIM | Subscriber Identity Module |
| 52. | TAC | Tracking Area Code |
| 53. | TAI | Tracking Area Identity |
| 54. | TAU | Tracking Area Update |
| 55. | TER | Terrestrial |
| 56. | TN | Terrestrial Networks |
| 57. | UCU | UE Configuration Update |
| 58. | UDM | Unified Data Management Function |
| 59. | UE | User Equipment |
| 60. | UL | Uplink |
| 61. | ULI | User Location Information |
| 62. | UPU | UE Parameters Update |
| 63. | USIM | Universal Subscriber Identification Module |
| 64. | Uu | The radio interface between the UE and the Node B |
| 65. | VPLMN | Visited Public Land Mobile Network |
| 66. | WB-S1 | Mode Wide Band with S1 Interface |

Satellite: an artificial body placed in orbit round the earth or moon or another planet in order to collect information or for communication.

Satellite constellation: group of satellites, placed in orbit round the earth or moon or another planet in order to collect information or for communication.

Service user: an individual who has received a priority level assignment from a regional/national authority (i.e., an agency authorized to issue priority assignments) and has a subscription to a mobile network operator.

Visited PLMN (VPLMN): this is a PLMN different from the HPLMN (if the EHPLMN list is not present or is empty) or different from an EHPLMN (if the EHPLMN list is present).

Allowable PLMN: in the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.

Available PLMN: PLMN(s) in the given area which is/are broadcasting capability to provide wireless communication services to the UE.

Camped on a cell: the MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.

EHPLMN: any of the PLMN entries contained in the Equivalent HPLMN list.

Equivalent HPLMN list: To allow provision for multiple HPLMN codes, PLMN codes that are present within the list replaces the HPLMN code derived from the IMSI for PLMN selection purposes. The list is stored on the USIM and is known as the EHPLMN list. The EHPLMN list may also contain the HPLMN code derived from the IMSI. If the HPLMN code derived from the IMSI is not present in the EHPLMN list then it may be treated as a Visited PLMN for PLMN selection purposes.

Home PLMN: this is a PLMN where the MCC and MNC of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: this is the process of camping on a cell of the PLMN or the SNPN and doing any necessary LRs.

UPLMN: PLMN/access technology combination in the “user controlled PLMN selector with access technology” data file in the SIM (in priority order);

OPLMN: PLMN/access technology combination in the “operator controlled PLMN selector with access technology” data file in the SIM (in priority order) or stored in the ME (in priority order)

The terms UE and MS are used interchangeably in the embodiment and have the same meaning.

The term area/location/geographical area are used in the embodiment may refer to any of cell/cell ID, TAC/TAI, PLMN, MCC/MNC, latitude/longitude, CAG cell or any geographical location/coordinate.

The solutions explained in the embodiment are applicable to any (but not limited to) of the RAT(s) as defined in the embodiment.

The network used in the embodiment could be any 5G/EUTRAN core network entities like AMF entity/SMF entity/MME entity/UPF entity or the network could be any (but not limited to) 5G/EUTRAN RAN Entity like eNodeB (eNB) or gNodeB (gNB) or NG-RAN etc.

Example for NAS messages are (but not limited to) as follows:

| | |
|---|---|
| 1. | REGISTRATION REQUEST message, |
| 2. | DEREGISTRATION REQUEST message, |
| 3. | SERVICE REQUEST message, |
| 4. | CONTROL PLANE SERVICE REQUEST, |
| 5. | IDENTITY REQUEST, |
| 6. | AUTHENTICATION REQUEST, |
| 7. | AUTHENTICATION RESULT, |
| 8. | AUTHENTICATION REJECT, |
| 9. | REGISTRATION REJECT, |
| 10. | REGISTRATION ACCEPT, |
| 11. | DEREGISTRATION ACCEPT, |
| 12. | SERVICE REJECT, |
| 13. | SERVICE ACCEPT, |
| 14. | UE CONFIGURATION UPDATE command, and |
| 15. | UE PARAMETERS UPDATE command. |

For a 5G system with satellite access, the following requirements apply:

1. The 5G system supports the service continuity between a NR terrestrial access network and a NR satellite access networks owned by the same operator or owned by 2 different operators having an agreement.

2. The NTN and TN could either operate in two different frequency bands (e.g., FR1 vs FR2), or in same frequency band (e.g., FR1 or FR2).

3. The terms satellite 3GPP access, satellite access, satellite access network, NR satellite access network, satellite NG-RAN access technology and NR satellite access have been interchangeably used and have the same meaning.

4. The methods, issues or solutions disclosed in the patent disclosure are explained using NR satellite access or satellite NG-RAN access technology as an example and is not restricted or limited to NR satellite access only. However, the solutions provided in the patent disclosure are also applicable for satellite E-UTRAN access technology, narrow band (NB)-S1 mode or wide band (WB)-S1 mode via satellite E-UTRAN access and/or narrow band Internet Of Things (NB-IOT) or wide band Internet Of Things (WB-IOT) satellite access/architecture.

5. The solutions which are defined for NR(5GC) are also applicable to legacy RATs like E-UTRA/LTE, the corresponding CN entities needs to be replaced by LTE entities for e.g., AMF entity with MME entity, g-nodeB with e-nodeB, UDM with HSS etc. But principles of the solution remains same.

6. An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

7. The network used in the embodiment is explained using any 5G core network Function for e.g., AMF entity. However, the network could be any 5G/EUTRAN core network entities like AMF entity/SMF entity/MME entity/UPF entity or the network could be any 5G/EUTRAN RAN Entity like eNodeB (eNB) or gNodeB (gNB) or NG-RAN etc.

8. The messages used or indicated in the embodiment are shown as an example. The messages could be any signalling messages between UE and the network functions/entities or between different network functions/entities.

9. The term area/location/geographical area are used in the embodiment may refer to any of cell/cell ID, TAC/TAI, PLMN, MCC/MNC, latitude/longitude, a CAG cell or any geographical location/coordinate.

The methods, issues or solutions disclosed in the embodiment are explained using NR access or NG-RAN access technology as an example and is not restricted or limited to NR access only. However, the solutions provided in the embodiment are also applicable for E-UTRAN access technology, NB-S1 mode or WB-S1 mode via E-UTRAN access and/or NB-JOT or WB-IOT access/architecture. The solutions which are defined for NR(5GC) are also applicable to legacy RATs like E-UTRA/LTE, the corresponding CN entities needs to be replaced by LTE entities for e.g., AMF entity with the MME entity, g-nodeB with e-nodeB, UDM with HSS etc. But principles of the solution remains same. The network used in the embodiment is explained using any 5G core network Function for e.g., AMF entity. However, the network could be any 5G/EUTRAN core network entities like AMF entity/SMF entity/MME entity/UPF entity or the network could be any 5G/EUTRAN RAN Entity like eNodeB (eNB) or gNodeB (gNB) or NG-RAN etc. The messages used or indicated in the embodiment are shown as an example. The messages could be any signalling messages between UE and the network functions/entities or between different network functions/entities. The terms camp and register are used interchangeably and have the same meaning.

The terms wait timer, DisCo wait timer, discontinuous coverage wait timer, random timer, random wait timer, DCW timer are all used interchangeably and have the same meaning. The terms wait range, disco wait range, discontinuous coverage wait range, DCW range are all used interchangeably and have the same meaning. For the list of possible NAS messages please refer to 3GPP TS 24.501 or 3GPP TS 24.301, for list of AS messages please refer to 3GPP TS 38.331 or 3GPP TS 36.331. The cause names in the embodiment are for illustration purpose and it can have any name. The non access stratum (NAS) messages and access stratum (AS) messages described in the embodiment is only for illustration purpose it can be any NAS or AS messages as per defined protocol between UE and AMF entity/MME entity or the UE and gNB(NG-RAN/any RAN node)/eNB.

The term 5GMM sublayer states in the patent embodiment are at least one of the below:
1) 5GMM-NULL;
2) 5GMM-DEREGISTERED:
   a) 5GMM-DEREGISTERED.NORMAL-SERVICE,
   b) 5GMM-DEREGISTERED.LIMITED-SERVICE,
   c) GMM-DEREGISTERED.ATTEMPTING-REGISTRATION,
   d) 5GMM-DEREGISTERED.PLMN-SEARCH,
   e) 5GMM-DEREGISTERED.NO-SUPI,
   f) 5GMM-DEREGISTERED.NO-CELL-AVAILABLE,
   g) 5GMM-DEREGISTERED.eCALL-INACTIVE, and/or
   h) 5GMM-DEREGISTERED.INITIAL-REGISTRATION-NEEDED;
3) 5GMM-REGISTERED-INITIATED;
4) 5GMM-REGISTERED:
   a) 5GMM-REGISTERED.NORMAL-SERVICE,
   b) 5GMM-REGISTERED.NON-ALLOWED-SERVICE,
   c) 5GMM-REGISTERED.ATTEMPTING-REGISTRATION-UPDATE,
   d) 5GMM-REGISTERED.LIMITED-SERVICE,
   e) 5GMM-REGISTERED.PLMN-SEARCH,
   f) 5GMM-REGISTERED.NO-CELL-AVAILABLE, and/or
   g) 5GMM-REGISTERED.UPDATE-NEEDED;
5) 5GMM-DEREGISTERED-INITIATED; and/or
6) 5GMM-SERVICE-REQUEST-INITIATED.

In the embodiment, the term EMM sublayer states are at least one of the below:
1) EMM-NULL;
2) EMM-DEREGISTERED:
   a) EMM-DEREGISTERED.NORMAL-SERVICE,
   b) EMM-DEREGISTERED.LIMITED-SERVICE,
   c) EMM-DEREGISTERED.ATTEMPTING-TO-ATTACH,
   d) EMM-DEREGISTERED.PLMN-SEARCH,
   e) EMM-DEREGISTERED.NO-IMSI,
   f) EMM-DEREGISTERED.ATTACH-NEEDED,
   g) EMM-DEREGISTERED.NO-CELL-AVAILABLE, and/or
   h) EMM-DEREGISTERED.eCALL-INACTIVE;
3) EMM-REGISTERED-INITIATED;
4) EMM-REGISTERED;
   a) EMM-REGISTERED.NORMAL-SERVICE,
   b) EMM-REGISTERED.ATTEMPTING-TO-UPDATE,
   c) EMM-REGISTERED.LIMITED-SERVICE,
   d) EMM-REGISTERED.PLMN-SEARCH,
   e) EMM-REGISTERED.UPDATE-NEEDED,
   f) EMM-REGISTERED.NO-CELL-AVAILABLE,
   g) EMM-REGISTERED.ATTEMPTING-TO-UPDATE-MM, and/or
   h) EMM-REGISTERED.IMSI-DETACH-INITIATED;
5) EMM-DEREGISTERED-INITIATED;
6) EMM-TRACKING-AREA-UPDATING-INITIATED; and/or
7) EMM-SERVICE-REQUEST-INITIATED.

The term RAT as defined in the embodiment can be one of the following:—
a) NG-RAN,
b) 5G, 4G, 3G, 2G,
c) EPS, 5GS,
d) NR,
e) NR in unlicensed bands,
f) NR(LEO) satellite access,
g) NR(MEO) satellite access,
h) NR(GEO) satellite access,
i) NR(OTHERSAT) satellite access,
j) NR RedCap,
k) E-UTRA,
l) E-UTRA in unlicensed bands,
m) NB-IoT,
n) WB-IoT, and/or
o) LTE-M.
5GS registration type are:
1. Initial registration;
2. Mobility registration updating;
3. Periodic registration updating;
4. Emergency registration;
5. SNPN onboarding registration;
6. Disaster roaming initial registration; and/or
7. Disaster roaming mobility registration updating.

PLMN selection as per 23.122 without RPLMN: the MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “user controlled PLMN selector with access technology” data file in the SIM (in priority order);
each PLMN/access technology combination in the “operator controlled PLMN selector with access technology” data file in the SIM (in priority order) or stored in the ME (in priority order);
other PLMN/access technology combinations with received high quality signal in random order; and
other PLMN/access technology combinations in order of decreasing signal quality.
PLMN selection as per 23.122 with RPLMN: the MS selects and attempts registration on any PLMN/access technology combinations, when available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “user controlled PLMN selector with access technology” data file in the SIM (in priority order);
each PLMN/access technology combination in the “operator controlled PLMN selector with access technology” data file in the SIM (in priority order) or stored in the ME (in priority order);
other PLMN/access technology combinations with received high quality signal in random order;
other PLMN/access technology combinations in order of decreasing signal quality.

Continuous coverage: in non terrestrial networks (NTN), continuous satellite coverage can be characterized by the fact that Uu interface is available for the UE, at a given position for 100% of the time.

Discontinuous coverage (DC): in non terrestrial networks (NTN), discontinuous satellite coverage can be characterized by the fact that Uu interface is available for the UE, at a given position, less than 100% of the time, due to predictable lack of satellite coverage. In yet another embodiment, discontinuous coverage is a deployment option for satellite E-UTRAN/NG-RAN access, in which shorter periods of satellite E-UTRAN/NG-RAN access radio coverage are followed by longer periods of satellite E-UTRAN/NG-RAN access coverage gaps. During coverage gaps, the access stratum may be deactivated. Due to discontinuous coverage, a UE may have access to satellite service coverage only at specific time and places.

Satellite ephemeris information: GPS satellites transmit information about their location (current and predicted), timing and “health” via what is known as ephemeris data. The data is used by the GPS receivers to estimate location relative to the satellites and thus position on earth. The ephemeris data can also be used to predict future satellite conditions (for a given place and time) providing a tool for planning when (or when not) to schedule GPS data collection.

Satellite coverage availability information: the satellite coverage availability information refers to location and time information related to expected coverage availability of satellite/satellite constellation that provides discontinuous coverage.

UE out-of-coverage period: the time period that UE is assumed to be out of coverage in case of NR/E-UTRAN satellite access that provides discontinuous coverage, based on satellite coverage availability information.

In an embodiment, the terms discontinuous coverage period and entering discontinuous coverage indication have same meaning and are used interchangeably. The indications are provided by UE to network when a UE is about to enter discontinuous coverage.

Embodiments disclosed herein provides, a system and method for handling PPF flag and MM BO timer for discontinuous coverage. A UE enters discontinuous coverage. The AMF entity stores the information that the UE is unavailable in UE context, and considers the UE is unreachable (i.e., clear the PPF in AMF entity) until the UE enters a CM-CONNECTED state or optionally until the UE triggers registration update procedure or optionally until UE triggers a mobile originating (MO) signalling or until the duration of the UE out-of-coverage period or UE expected unavailability duration (as determined by the AMF entity or indicated by the UE or based on the satellite coverage availability information), which ever happens earlier. Discontinuous coverage period is over. If the AMF entity determines that the discontinuous coverage period is over or UE out-of-coverage period/UE expected unavailability duration (as determined/indicated by the AMF entity or indicated by the UE or negotiated between UE and the AMF entity or based on the satellite coverage availability information or by any method or parameter) is over and the UE has still not entered a CM-CONNECTED state (i.e., the UE out-of-coverage period/UE expected unavailability duration (as determined/indicated by the AMF entity or indicated by the UE or negotiated between UE and the AMF entity or based on the satellite coverage availability information) is over before UE enters a CM-CONNECTED state or before the UE CM state in the AMF entity is changed to a CM-CONNECTED state), the AMF entity sets the paging proceed fa lag (PPF) in the AMF entity, optionally for the UE. Upon returning in coverage after being out of coverage due to discontinuous coverage, the UE may be in a CM-IDLE state. If the AMF entity has some paging/DL data or MT-signalling for the UE, the AMF entity may page the UE or the AMF entity triggers the paging procedure for any pending paging/signalling/downlink data, if any, for the UE.

The AMF entity may detect 5GMM signalling congestion and perform general NAS level congestion control. Under the 5GMM signalling congestion conditions, the AMF entity may reject 5GMM signalling requests (for example, registration request messages or service request messages) from the UE with a mobility management back-off timer (for example, timer T3346). While the mobility management back-off timer (MM BO timer) (for example, timer T3346) is running, the UE may perform one or more of the below methods/procedures in any order or combinations:
the UE, optionally supporting discontinuous coverage functionalities, may initiate any AS or NAS signalling message (for e.g., registration request procedure/messages (for initial registration or mobility registration update procedures) or service request procedures) to indicate/negotiate to/with the network regarding the discontinuous coverage period or UE out-of-coverage period or UE unavailability period or unavailability information when the UE is about to lose coverage due to discontinuous coverage or before the UE enters the discontinuous coverage.

The UE, supporting discontinuous coverage functionalities, may optionally provide/indicate “discontinuous coverage support” indication as part of 5GMM core network Capability in the registration request message for initial registration or mobility registration update.

The UE may optionally indicate the AS/NAS mobility management message (AS/NAS MM message) (for e.g., registration request message for initial registration/mobility registration update or service request message) for discontinuous coverage support/discontinuous coverage period or UE out-of-coverage period or UE unavailability period or unavailability information negotiation/indication is exempted from NAS congestion control. When the NAS MM congestion control is activated at AMF entity/any network Function, if the UE indicates that the NAS MM message is exempted from NAS congestion control, the AMF entity may not reject the NAS MM message.

The UE may stop the mobility management back-off timer (MM BO timer) (for e.g., timer T3346), if running, before/after initiating the AS/NAS signalling message for discontinuous coverage support/period indication/negotiation. In yet another embodiment, the UE may continue to run the mobility management back-off timer (MM BO timer) (for e.g., timer T3346), if running, before/after initiating the AS/NAS signalling message for discontinuous coverage support/period indication/negotiation.

In another aspect the present disclosure provides a system and method for handling PPF flag and MM BO timer for discontinuous coverage. The AMF entity stores the information that the UE is unavailable in UE context, and considers the UE is unreachable when UE enters discontinuous coverage. Further the AMF entity set the PPF in the AMF entity and allow paging for any downlink data/signalling when the UE discontinuous coverage period is over. Furthermore, solution is provided related to cases where the UE trigger MRU while MM BO is running, network adjusts MM BO in such a way that UE can trigger MRU as MM BO finishes before discontinuous coverage (DC) starts, the UE triggers MRU (normal), network can adjust MM BO in such a way that UE does not detach, network not rejecting when the UE indicates unavailability period, and the network rejects in such a way that UE does not detach when the UE indicates unavailability period.

The methods can be used for handling start time in satellite communications. The UE can update/indicate the start time and unavailability period at the AMF entity/network. The AMF entity/network behaviour is defined, when any subsequent mobility registration update or any other NAS procedure with or without start time and unavailability period information is received.

The NTN and TN could either operate in two different frequency bands (e.g., FR1 vs FR2), or in same frequency band (e.g., FR1 or FR2). The terms satellite 3GPP access, satellite access, satellite access network, NR satellite access network, satellite NG-RAN access technology and NR satellite access have been interchangeably used herein and have the same meaning.

The solutions provided in these embodiments are also applicable for satellite E-UTRAN access technology, NB-S1 mode or WB-S1 mode via satellite E-UTRAN access and/or NB-IOT or WB-IOT satellite access/architecture.

The solutions which are defined for NR (5GC) are also applicable to legacy RATs like E-UTRA/LTE, the corresponding CN entities needs to be replaced by LTE entities for e.g., AMF entity with the MME entity, g-nodeB with e-nodeB, UDM with HSS etc. But principles of the solution remain same.

The network used in the embodiment is explained using any 5G core network Function; for e.g., AMF entity. However, the network could be any 5G/EUTRAN core network entities like AMF entity/SMF entity/MME entity/UPF entity or the network could be any 5G/EUTRAN RAN Entity like eNodeB (eNB) or gNodeB (gNB) or NG-RAN etc.

The messages used or indicated herein are shown as an example. The messages could be any signalling messages between UE and the network functions/entities or between different network functions/entities.

The terms unavailability period and UE out-of-coverage period are used interchangeably and have the same meaning.

The messages used or indicated herein are shown as an example. The messages could be any signalling message between the UE and the network functions/entities or between different network functions/entities. The terms camp and register are used interchangeably and have the same meaning. The terms wait timer, DisCo wait timer, discontinuous coverage wait timer, Random timer, Random wait timer, DCW timer are all used interchangeably and have the same meaning. The terms wait range, Disco Wait Range, discontinuous coverage Wait Range, DCW Range are all used interchangeably and have the same meaning. The terms unavailability period, unavailability duration and unavailability timer are all interchangeably used and have the same meaning. For the list of possible NAS messages, please refer to 3GPP TS 24.501 or 3GPP TS 24.301, for list of AS messages please refer to 3GPP TS 38.331 or 3GPP TS 36.331. The cause names herein are for illustration purpose and it can have any name. The NAS messages and access stratum (AS) messages described in the embodiment is only for illustration purpose; it can be any NAS or AS messages as per protocols defined between the UE and the AMF entity/MME entity or the UE and the gNB (NG-RAN/any RAN node)/eNB.

In an embodiment, once the UE has set start time and unavailability period, if the UE triggers registration procedure for whatever reason in the future till unavailability period is still ongoing, the UE may mandatorily include them (unavailability information) again with the reference value. For e.g., first time UE set start time (60 mins)+unavailability period (2 hours). Then if registration is triggered after 30 mins, then now UE may set 30 mins+2 hours (i.e., now star time is reduced by 30 mins). The network blindly updates the values the network receives from the UE.

In an embodiment, the UE may trigger registration procedure (a new trigger due to change in start time or unavailability) and include this values. The AMF entity when the AMF receives new values updates in UE context at the AMF entity (i.e., the AMF entity does not do any calculation).

In an embodiment, the UE may trigger registration procedure(a new trigger for deletion of start time and unavailability period) and NOT include this start-time and unavailability period IE. When the AMF entity receives registration request message without the Ies(i.e., unavailability information) then the AMF entity may delete the unavailability information(i.e., start time and unavailability period).

The principal object of the embodiments herein is to a method for managing a context associated with a UE during a discontinuous coverage scenario in a telecommunication network.

Another object of the embodiments herein is to disclose that the UE needs to report unavailability period duration(unavailability information) due to discontinuous coverage, or to indicate unavailability due to discontinuous coverage then the UE is allowed to initiate 5GMM procedures, while a network has started NAS level congestion control.

Another object of the embodiments herein is to disclose that the AMF entity may not reject the requests for mobility registration update when the UE is reporting unavailability period due to discontinuous coverage or indicating unavailability due to discontinuous coverage while the network has started NAS level congestion control.

Another object of the embodiments herein is to disclose that the network apparatus updates the MRT and IDT timers so that UE is not deregistered at the network when it's in discontinuous coverage of satellite access and when the UE reports unavailability period to the network apparatus.

Another object of the embodiments herein is to disclose methods for handling start time in satellite communications, where the UE can update/indicate the start time and unavailability period at the AMF entity/network.

Another object of the embodiments herein is to disclose methods for handling start time in satellite communications, wherein the AMF entity/network behaviour is defined, when any subsequent mobility registration update or any other NAS procedure with or without start time and unavailability period information is received.

Another object of the embodiments herein is to disclose that once the UE has set start time and unavailability period(i.e., unavailability information), if the UE triggers the registration procedure for whatever reason in the future till unavailability period, the UE may mandatorily include them again with the reference value. For example, the first time UE sets the start time (60 mins)+unavailability period (2 hours). Then if registration is triggered after 30 mins, then now the UE may set 30 mins+2 hours (i.e., now star time is reduced by 30 mins). The network blindly updates the values the network receives from the UE.

Another object of the embodiments herein is to disclose that the UE may trigger registration procedure (a new trigger due to change in unavailability information e.g., start time or unavailability period duration) and include this values. The AMF/MME when the AMF/MME receives new values updates in UE context at the AMF/MME entity (i.e., The AMF entity does not do any calculation).

Another object of the embodiments herein is to disclose that the UE may trigger registration procedure (a new trigger for deletion of unavailability information i.e., start time and unavailability period) and NOT include this start-time and unavailability period IE. When the AMF entity receives registration request message without the Ies then, the AMF entity will delete any stored unavailability information e.g., the start time and unavailability period.

In discontinuous coverage of a satellite scenario, UE(s) have coverage at only specific times and places due to the continuous movement of satellites or satellite constellations. Due to the discontinuous coverage, the UE may have access to satellite service coverage only at specific time and places. In discontinuous coverage of the satellite scenario, the UE(s) are bound to have coverage at only specific times due to the continuous movement of the satellites or the satellite constellations. The UE can determine that the UE is about to leave a network coverage based on coverage information or any other information, e.g., satellite ephemeris, while the UE is in either a CONNECTED mode or an IDLE mode. When the UE(s) are about to get the satellite coverage after specific time, the UE may initiate signalling towards a network due to any UL traffic or NAS layer signalling. Few of the power saving mechanisms/timers/parameters, but not restricted or limited to only these, are used herein:
Active time/MICO mode with active time,
Extended connected time/MICO mode with extended connected time,
Periodic TAU timer/periodic update timer,
Periodic registration timer/periodic registration update timer, and
eDRX parameters (such as cycle length).

For NR satellite access that provides discontinuous network coverage, the UE out-of-coverage period may be determined, which indicates the timing information for when the UE is expected to be out of coverage, and when the UE is expected to re-gain coverage again. The UE out-of-coverage period may consider current and expected future locations of the UE. When the UE is able to determine its own UE out-of-coverage period, and decides to remain in no service the. The UE triggers a mobility registration update procedure to inform the network of its UE out-of-coverage period.

FIG. 1 illustrates a scenario of handling PPF flag and MM BO timer for discontinuous coverage in accordance with some embodiments of the present disclosure. The UE (100) enters the discontinuous coverage. The AMF entity (300) stores the information about that the UE (100) is unavailable in the UE context, and considers the UE (100) is unreachable (i.e., clear the PPF in the AMF entity (300)) until the UE (100) enters a CM-CONNECTED state or optionally until the UE (100) triggers registration update procedure or optionally until the UE (100) triggers a mobile originating (MO) signalling. The discontinuous coverage period is over. The AMF entity (300) has some paging/DL data or MT-signalling for the UE (100). Upon returning in coverage after being out of coverage due to discontinuous coverage, the UE (100) may be in an CM-IDLE state. If the AMF entity (300) has some paging/DL data or MT-signalling for the UE (100), the AMF entity (300) is unable to page the UE (100) as PPF is not set (i.e., PPF is cleared in AMF entity (300) for the UE (100)) until the UE (100) enters the CM-CONNECTED state or optionally until the UE (100) triggers the registration update procedure or optionally until the UE (100) triggers a mobile originating (MO) signalling. This may lead to delay in paging the UE (100) even though the UE (100) is out of discontinuous coverage (i.e., when UE (100) returns in coverage after being out of coverage due to discontinuous coverage). The UE (100) may move to the CM-CONNECTED state or optionally trigger the registration update procedure or optionally trigger a mobile originating (MO) signalling. The AMF entity (300) pages the UE (100) or send the DL data/MT-signalling to the UE (100).

The NAS level congestion control is achieved by providing a back-off time(also called as MM back off timer or timer T3346) to the UE (100). To avoid that large amounts of UEs (100) initiate deferred requests (almost) simultaneously, a 5GC selects each back-off time value so that the deferred requests are not synchronized. When the UE (100) receives the back-off time, the UE (100) does not initiate any NAS signalling with regards to the applied congestion control until the back-off timer expires or the UE (100) receives a mobile terminated request from the network, or the UE (100) initiates signalling for emergency services or high priority access. The AMF entities and SMF entities may apply NAS level congestion control, but may not apply NAS level congestion control for procedures not subject to congestion control. While the mobility management back-off timer is running, the UE (100) does not initiate any NAS request except for deregistration procedure and procedures not subject to congestion control (e.g., high priority access, emergency services or the like) and mobile terminated services. After any such deregistration procedure, the back-off timer continues to run.

When the NAS MM congestion control is activated at the AMF entity (300), if the UE (100) indicates that the NAS MM message is exempted from the NAS congestion control, the AMF entity (300) does not reject the NAS MM message and forwards the NAS SM message to the corresponding SMF entity with an indication that the NAS SM message was indicated to be exempted from the NAS congestion control. If the AMF entity (300) rejects the registration request messages or service request with a mobility management back-off time which is larger than the sum of the UE(s) (100) periodic registration update timer and the implicit deregistration timer, the AMF entity (300) adjusts the mobile reachable timer and/or implicit deregistration timer such that the AMF entity (300) does not implicitly deregister the UE (100) while the mobility management back-off timer is running.

The AMF entity (300) may detect 5GMM signalling congestion and perform general NAS level congestion control. Under the 5GMM signalling congestion conditions, the AMF entity (300) may reject 5GMM signalling requests from the UE(s) (100). The AMF entity (300) may not reject the following:
Requests for the emergency services,
Requests for the emergency services fallback,
Requests from the UE (100) configured for high priority access in selected PLMN or SNPN,
DEREGISTRATION REQUEST message,
Requests for mobile terminated services, triggered by paging or a notification procedure, and
Requests for initial registration or mobility and periodic registration update, when emergency is indicated by lower layers.

When a general NAS level congestion control is active, the AMF entity (300) may include a value for the mobility management back-off timer T3346 in the reject messages. The UE (100) starts the timer T3346 with the value received in the 5GMM reject messages. If the initial registration request is rejected due to general NAS level mobility management congestion control, the network sets the 5GMM cause value to #22 “congestion” and assign a value for back-off timer T3346. If the mobility and periodic registration update request is rejected due to general NAS level mobility management congestion control, the network sets the 5GMM cause value to #22 “congestion” and assign a value for back-off timer T3346.

The AMF entity (300) may detect 5GMM signalling congestion and perform general NAS level congestion control. Under the 5GMM signalling congestion conditions, the AMF entity (300) may reject 5GMM signalling requests (for e.g., registration request messages or service request messages) from the UE (100) with a mobility management back-off timer (For e.g., timer T3346). While the mobility management back-off timer is running, the UE (100) does not initiate any NAS request except for deregistration procedure and procedures not subject to congestion control (e.g., high priority access, emergency services) and mobile terminated services.

While the mobility management back-off timer (MM BO timer) (for e.g., timer T3346) is running, the UE (100) may lose coverage due to discontinuous coverage or the UE (100) may enter the discontinuous coverage. After the mobility management back-off timer ends, the UE (100) may initiate any NAS signalling towards the network. However, since the UE (100) has already entered discontinuous coverage, the UE (100) may not be able to initiate any AS/NAS signalling towards the network. If the UE(s) periodic registration update timer or the implicit deregistration timer or the sum of the periodic registration update timer and the implicit deregistration timer expires at the network function (for e.g., AMF entity (300)), a network function entity (for e.g., AMF entity (300)) may implicitly deregister/detach the UE (100), optionally since the UE (100) did not indicate/negotiate to the network that the UE (100) is about to enter/is entering/is in the discontinuous coverage.

This is not a correct behaviour as the network does not deregister/detach the UE (100) while the UE (100) is in the discontinuous coverage. For example, the UE (100) gets a mobility management back-off timer (for e.g., timer T3346) from the network at 10 am with a timer value of 1 hour. The implicit deregistration timer may be set to a value of 1.5 hours. The UE (100) runs the mobility management back-off timer from 10 am to 11 am (of duration 1 hour). At 10.30 am, the UE (100) may enter discontinuous coverage for 2 hours duration (10.30 am-12.30 pm). The network may run an implicit deregistration timer from the UE (100) from 10 am with a duration of 1.5 hours (10 am-11.30 am). Since the UE (100) entered discontinuous coverage and network is not aware that the UE (100) has entered discontinuous coverage, the network may implicitly deregister/detach the UE (100).

At step 1, the UE (100) enters discontinuous coverage. At step 2, the AMF entity (300) stores the information that the UE (100) is unavailable in UE context, and considers the UE (100) is unreachable (i.e., clear the PPF in AMF entity (300)) until the UE (100) enters a CM-CONNECTED state or optionally until UE (100) triggers registration update procedure or optionally until UE (100) triggers a mobile originating (MO) signalling. At step 3, the discontinuous coverage period is over. At step 4, the AMF entity (300) has some paging/DL data or MT-signalling for the UE (100). At step 5, upon returning in coverage after being out of coverage due to discontinuous coverage, the UE (100) may be in a CM-IDLE state. At step 6, if the AMF entity (300) has some paging/DL data or MT-signalling for the UE (100), The AMF entity (300) is unable to page UE (100) as PPF is not set (i.e., PPF is cleared in AMF entity (300) for the UE (100)) until the UE (100) enters the CM-CONNECTED state or optionally until UE (100) triggers registration update procedure or optionally until UE (100) triggers a mobile originating (MO) signalling. This may lead to delay in paging the UE (100) even though the UE (100) is out of discontinuous coverage (i.e., when UE (100) returns in coverage after being out of coverage due to discontinuous coverage). At step 7, the UE (100) may move to the CM-CONNECTED state or optionally trigger registration update procedure or optionally trigger a mobile originating (MO) signalling. At step 8a and step 8b, the AMF entity (300) pages the UE (100) or send the DL data/MT-signalling to the UE (100) through the gNB.

For the 5G system with satellite access, the following requirements apply such as the 5G system supports the service continuity between NR terrestrial access network and NR satellite access networks owned by the same operator or owned by 2 different operators having an agreement.

If the UE (100) indicates an unavailability period duration, then the AMF entity (300) considers that the UE (100) is unreachable and the AMF entity (300) may not trigger the paging procedure (e.g., clear the PPF) until the UE (100) registers for normal service again (e.g., set the PPF). Once the event that makes the UE (100) unavailable is completed or cancelled in the UE (100), the UE (100) initiates the registration procedure in order to resume normal service.

UE unreachability due to unavailability period: mobile originated data and mobile terminated data are not transmitted in the category (handling of data by extending buffering may apply). The paging procedure is not applicable to the category.

Before the start of an event that makes the UE (100) unavailable, the UE (100) includes the unavailability period duration and triggers either mobility registration update or UE (100) initiated deregistration procedure:
a) If the UE (100) initiates mobility registration update procedure:

The AMF entity (300) may take the unavailability period duration into account when determining periodic registration update timer value. The AMF entity (300) may provide a periodic registration update time longer than or equal to unavailability period duration to avoid interfering with the UE (100) dealing with the event that causes the unavailability;
The AMF entity (300) stores the information that the UE (100) is unavailable in the UE context, and considers the UE (100) is unreachable (i.e., clear the PPF in AMF entity (300)) until the UE (100) enters the CM-CONNECTED state;
While the UE (100) is unreachable, all high latency communication solutions (see clause 5.31.8) apply if supported in the network, e.g., extended data buffering, downlink data buffering status report, etc.; and
If there is “loss of connectivity” event subscription for the UE (100) by the AF, the AMF entity (300) considers the remaining time in the unavailability period when constructing the “loss of connectivity” event report towards the NEF and the unavailability period is reported to the respective subscribed AF.
b) If the UE (100) initiates UE (100)-initiated deregistration procedure:

If there is “loss of connectivity” event subscription for the UE (100) by AF, the AMF entity (300) considers the remaining time in the unavailability period when constructing the “loss of connectivity” event report towards the NEF and the unavailability period is reported to the respective subscribed AF.

Once the event which makes the UE (100) unavailable is completed in the UE (100) or the event is delayed to a future time or cancelled in the UE (100), the UE (100) triggers registration procedure to resume regular service. The UE (100) does not include the unavailability period in the registration request message. Depending on the UE (100) state, the registration procedure can be initial registration procedure or mobility registration update procedure.

The UE (100) can initiate mobility registration update procedure for unavailability duration in advance of UE (100) out-of-coverage period. In this case, the UE (100) needs to indicate start time in the message. The UE (100) may include start time in mobility registration update along with unavailability duration information to indicate to network when the unavailability period may start. Start time could be absolute time (e.g., UTC time) or a time duration relative to the time of receipt of the unavailability period at the AMF entity (300) or relative to any other reference time/NAS procedure/RRC connection release (or any other RRC procedure) optionally successful execution of the procedure. When the current time equals the start time sent by the UE (100) in mobility registration update, or the time duration from the reference time is over, the network considers the UE (100) unreachable for the unavailability period and may not page the UE (100) for any DL data/signalling. If the UE (100) does not include start time in mobility registration update message, the network may start the unavailability duration timer immediately and may consider the UE (100) unreachable for the unavailability period.

The UE (100) performs mobility registration update procedure and informs the network of start time and unavailability period(also called as unavailability information). The network updates the UE context with received information of start time and unavailability period. Later due to some changes in the UE (100) or due to some other procedure, UE (100) performs mobility registration update procedure or any other NAS procedure. Or the UE (100) wants to update/indicate a change to network/AMF entity (300) in the start time or unavailability period or both the start time and unavailability period.

It is not clear as to what procedure that the UE (100) may use to update/indicate the start time and unavailability period at the AMF entity (300)/network is not yet defined.

It is not clear as to what actions may the AMF entity (300)/network take, when any subsequent mobility registration update or any other NAS procedure with or without start time and unavailability period information is received. Such a scenario is also not defined in the existing solutions.

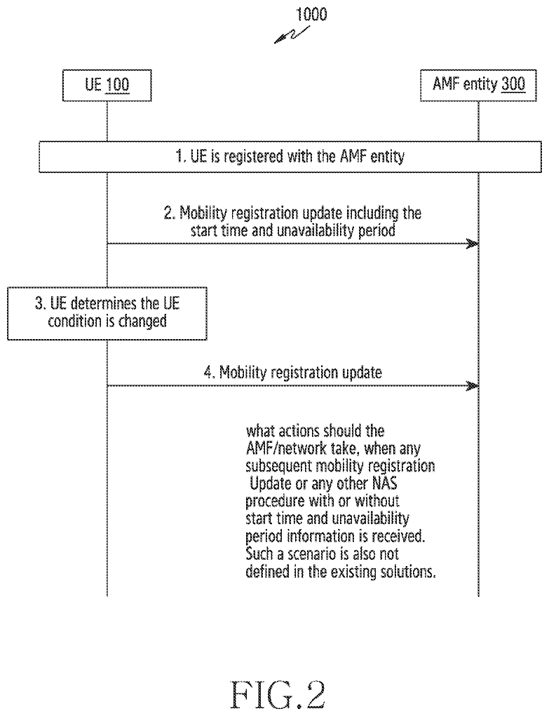

FIG. 2 illustrates a scenario, wherein the AMF entity (300)/network behaviour when any subsequent mobility registration update or any other NAS procedure with or without start time and unavailability period information is received is also not defined in the existing solutions.

At step 1, the UE (100) is registered with the AMF entity (300). At step 2, the UE (100) sends the mobility registration update including the start time and unavailability period. At step 3, the UE (100) determines the UE (100) condition is changed. At step 4, the UE (100) sends the mobility registration update to the AMF entity (300). In that scenario, there are chances that UE and network(like AMF or MME) can be out of sync, because the UE may delete unavailability information but AMF may consider the old value the AMF has or the UE may continue to apply the last indicated value and AMF/network may delete, i.e., when any subsequent mobility registration update or any other NAS procedure with or without start time and unavailability period information(unavailability information) is received how and what actions the UE and the network may take. Such a scenario is also not defined in the existing solutions.

The above information is presented as background information only to help the reader to understand the present disclosure. Applicants have made no determination and make no assertion as to whether any of the above might be applicable as prior art with regard to the present application.

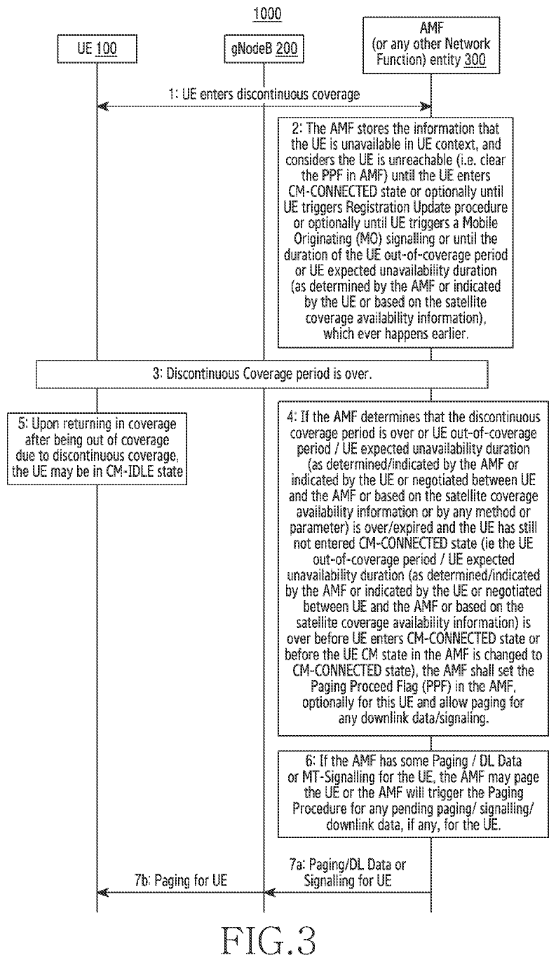

Referring now to the drawings, and more particularly to FIGS. 3 through 11, where similar reference characters denote corresponding features consistently throughout the figures, there are shown at least one embodiment.

FIG. 3 illustrates a scenario of handling PPF flag and MM BO timer for discontinuous coverage according to the embodiments as disclosed herein. At step 1, the UE (100) enters discontinuous coverage. At step 2, the AMF stores the information that the UE (100) is unavailable in UE context, and considers the UE (100) is unreachable (i.e., clear the PPF in AMF) until the UE (100) enters the CM-CONNECTED state or optionally until UE (100) triggers registration update procedure or optionally until UE (100) triggers a mobile originating (MO) signalling or until the duration of the UE (100) out-of-coverage period or UE (100) expected unavailability duration (as determined by the AMF or indicated by the UE (100) or based on the satellite coverage availability information), which ever happens earlier. At step 3, the discontinuous coverage period is over.

At step 4, if the AMF determines that the discontinuous coverage period is over or UE (100) out-of-coverage period/UE (100) expected unavailability duration (as determined/indicated by the AMF or indicated by the UE (100) or negotiated between UE (100) and the AMF or based on the satellite coverage availability information or by any method or parameter) is over/expired and the UE (100) has still not entered the CM-CONNECTED state (i.e., the UE (100) out-of-coverage period/UE (100) expected unavailability duration (as determined/indicated by the AMF or indicated by the UE (100) or negotiated between the UE (100) and the AMF or based on the satellite coverage availability information) is over before the UE (100) enters the CM-CONNECTED state or before the UE (100) CM state in the AMF is changed to the CM-CONNECTED state), the AMF may set the paging proceed flag (PPF) in the AMF, optionally for this UE (100) and allow paging for any downlink data/signaling. At step 5, upon returning in coverage after being out of coverage due to discontinuous coverage, the UE (100) may be in the CM-IDLE state. At step 6, if the AMF has some paging/DL data or MT-signalling for the UE (100), the AMF may page the UE (100) or the AMF may trigger the paging procedure for any pending paging/signalling/downlink data, if any, for the UE (100).

When the UE (100) is about to lose coverage due to discontinuous coverage or the UE (100) enters the discontinuous coverage, the AMF entity (300) performs the at least one or more of the below methods or procedures, in any order or combinations (optionally if the AMF entity (300) has not indicated to the UE (100) that the UE (100) is required to perform registration procedure or NAS procedure on returning to coverage and get into connected mode):

The AMF entity (300) stores the information that the UE (100) is unavailable in the UE context, and considers the UE (100) is unreachable (i.e., clear the paging proceed flag (PPF) in AMF entity (300)) and optionally, the AMF entity (300) may not trigger the paging procedure until the UE (100) enters a CM-CONNECTED state or until the duration of the UE (100) out-of-coverage period or UE (100) expected unavailability duration (as determined by the AMF entity (300) or indicated by the UE (100) or based on the satellite coverage availability information or by any method or parameter), whichever is earlier. Upon returning in coverage after being out of coverage due to discontinuous coverage, if the UE (100) enters the CM-CONNECTED state or if the AMF entity (300) determines the UE (100) CM state in the AMF entity (300) as the CM-CONNECTED state or if the AMF entity (300) determines that the discontinuous coverage period or UE (100) out-of-coverage period is over (based on the satellite coverage availability information or based on AMF entity (300) determination or based on indicated by the UE (100) or by any method or parameter), the AMF entity (300) sets the paging proceed flag (PPF) in the AMF entity (300), optionally for the UE (100), and may page the UE (100) or the AMF entity (300) triggers the paging procedure for any pending paging/signalling/downlink data, if any.

When the UE (100) is about to lose coverage due to discontinuous coverage or the UE (100) enters the discontinuous coverage (as indicated by the UE (100) or as determined by the AMF entity (300)), the AMF entity (300) may optionally start a timer T for the duration of UE (100) out-of-coverage period (as determined by the AMF entity (300) or indicated by the UE (100) or based on the satellite coverage availability information or by any method or parameter) and considers the UE (100) is unreachable (i.e., clear the paging proceed flag (PPF) in AMF entity (300)) and optionally, the AMF entity (300) may not trigger the paging procedure until the UE (100) enters a CM-CONNECTED state or until the timer T stops/ends/expires, whichever happens earlier. Upon returning in coverage after being out of coverage due to discontinuous coverage, if the UE (100) enters the CM-CONNECTED state or if the AMF entity (300) determines the UE (100) CM state in the AMF entity (300) as the CM-CONNECTED state or if the AMF entity (300) determines that the discontinuous coverage period or UE (100) out-of-coverage period is over (based on the satellite coverage availability information or based on AMF entity (300) determination or based on indicated by the UE (100) or by any method or parameter) or if the timer T expires, whichever happens first, the AMF entity (300) stops the timer T, if still running, and the AMF entity (300) sets the paging proceed flag (PPF) in the AMF entity (300), optionally for the UE (100), and may page the UE (100) or the AMF entity (300) triggers the paging procedure for any pending paging/signalling/downlink data, if any.

The AMF entity (300) stores the information that the UE (100) is unavailable in the UE context, and considers the UE (100) is unreachable (i.e., clear the paging proceed flag (PPF) in AMF entity (300)) until the UE (100) enters a CM-CONNECTED state or until the duration of the UE (100) out-of-coverage period (as determined by the AMF entity (300) or indicated by the UE (100) or based on the satellite coverage availability information or by any method or parameter) or until the UE (100) triggers registration update procedure when the UE returns to coverage using any access type or until the UE (100) triggers any MO-signalling (NAS or AS signalling message), whichever happens earlier and the AMF entity (300) sets the paging proceed flag (PPF) in the AMF entity (300), optionally for the UE (100), and may page the UE (100) or the AMF entity (300) triggers the paging procedure for any pending paging/signalling/downlink data, if any, whenever any of these events/procedure is determined first by the AMF entity (300).

In an embodiment, when the UE (100) is not able to determine the UE (100)'s own UE (100) out-of-coverage period but can determine that the UE (100) is about to lose coverage, the following applies:

The UE (100) triggers the mobility registration update procedure and indicates that the UE (100) is about to lose coverage due to discontinuous coverage but does not provide a UE (100) out-of-coverage period.

In this case, when the AMF entity (300) is able to determine a UE (100) out-of-coverage period based on satellite coverage availability information, as described below, the AMF entity (300) provides an expected unavailability duration to the UE (100) in the registration Accept. The AMF entity (300) may take the out of coverage period into account when determining periodic registration update timer value for the UE (100). The AMF entity (300) stores the information that the UE (100) is unavailable in the UE context, and considers the UE (100) is unreachable (i.e., clear the PPF in AMF entity (300)) until the UE (100) enters the CM-CONNECTED state or until the duration of the UE (100) out-of-coverage period/UE (100) expected unavailability duration (as determined/indicated by the AMF entity (300) or indicated by the UE (100) or negotiated between UE (100) and the AMF entity (300) or based on the satellite coverage availability information or by any method or parameter), which ever happens earlier. (i.e., if the UE (100) enters the CM-CONNECTED state before the UE (100) out-of-coverage period/UE (100) expected unavailability duration is over, the AMF entity (300) sets the PPF in AMF entity (300), optionally for the UE (100). Similarly, if the duration of the UE (100) out-of-coverage period/UE (100) expected unavailability duration (as determined/indicated by the AMF entity (300) or indicated by the UE (100) or negotiated between UE (100) and the AMF entity (300) or based on the satellite coverage availability information) is over before UE (100) enters the CM-CONNECTED state (i.e., before UE (100) enters the CM-CONNECTED state), the AMF entity (300) sets the PPF in AMF entity (300), optionally for the UE (100).

In an embodiment, if the AMF entity (300) determines that the discontinuous coverage period is over or UE (100) out-of-coverage period/UE (100) expected unavailability duration (as determined/indicated by the AMF entity (300) or indicated by the UE (100) or negotiated between UE (100) and the AMF entity (300) or based on the satellite coverage availability information or by any method or parameter) is over and the UE (100) has still not entered a CM-CONNECTED state (i.e., the UE (100) out-of-coverage period/UE (100) expected unavailability duration (as determined/indicated by the AMF entity (300) or indicated by the UE (100) or negotiated between the UE (100) and the AMF entity (300) or based on the satellite coverage availability information) is over before UE (100) enters the CM-CONNECTED state or before the UE (100) CM state in the AMF entity (300) is changed to the CM-CONNECTED state), the AMF entity (300) sets the paging proceed flag (PPF) in the AMF entity (300), optionally for the UE (100), and may page the UE (100) or the AMF entity (300) triggers the paging procedure for any pending paging/signalling/downlink data, if any, for the UE (100).

In an embodiment, the AMF entity (300), optionally, sets the PPF in the AMF entity (300), optionally for the determined UE (100), only if there is any pending paging data or procedure/any pending signalling (AS or NAS signalling) for the UE (100)/any pending/buffered downlink data for the UE (100).

In another embodiment, if the AMF entity (300) has indicated to the UE (100) that the UE (100) is required to perform the registration procedure returning to coverage then AMF entity (300) waits for UE (100) to come to connected state before setting the PPF flag and allow paging for the UE (100) for any downlink signalling or data.

The AMF entity (300) may detect 5GMM signalling congestion and perform general NAS level congestion control. Under the 5GMM signalling congestion conditions, the AMF entity (300) may reject 5GMM signalling requests (for e.g., registration request messages or service request messages) from the UE (100) with a mobility management back-off timer (For e.g., timer T3346). While the mobility management back-off timer (MM BO timer) (for e.g., timer T3346) is running, the UE (100) may perform one or more of the below methods/procedures in any order or combinations:
the UE (100), optionally supporting discontinuous coverage functionalities, may initiate any AS or NAS signalling message (for e.g., registration request procedure/messages (for initial registration or mobility registration update procedures) or service request procedures) to indicate/negotiate to/with the network regarding the discontinuous coverage period or UE (100) out-of-coverage period or UE (100) unavailability period when the UE (100) is about to lose coverage due to discontinuous coverage or before the UE (100) enters the discontinuous coverage.

The UE (100), supporting discontinuous coverage functionalities, may optionally provide/indicate “discontinuous coverage support” indication as part of 5GMM core network Capability in the registration request message for initial registration or mobility registration update.

The UE (100) may optionally indicate the AS/NAS mobility management message (AS/NAS MM message) (for e.g., registration request message for initial registration/mobility registration update or service request message) for discontinuous coverage support/discontinuous coverage period or UE (100) out-of-coverage period or UE (100) unavailability period negotiation/indication is exempted from NAS congestion control. When the NAS MM congestion control is activated at AMF entity (300)/any network Function, if the UE (100) indicates that the NAS MM message is exempted from NAS congestion control, the AMF entity (300) does not reject the NAS MM message.

The UE (100) may stop the mobility management back-off timer (MM BO timer) (for e.g., timer T3346), if running, before/after initiating the AS/NAS signalling message for discontinuous coverage support/period indication/negotiation. In yet another embodiment, the UE (100) may continue to run the mobility management back-off timer (MM BO timer) (for e.g., timer T3346), if running, before/after initiating the AS/NAS signalling message for discontinuous coverage support/period indication/negotiation.

For example, the UE (100) gets a mobility management back-off timer (for e.g., timer T3346) from the network at 10 am with a timer value of 1 hour. The implicit deregistration timer may be set to a value of 1.5 hours. UE (100) runs the mobility management back-off timer from 10 am to 11 am (of duration 1 hour). At 10.30 am, the UE (100) may be about to enter discontinuous coverage for 2 hours duration (10.30 am-12.30 pm). While the mobility management back-off timer (MM BO timer) (for e.g., timer T3346) (of duration 1 hr) is running, the UE (100), optionally supporting discontinuous coverage functionalities, may initiate any AS or NAS signalling message (for e.g., registration request procedure/messages (for initial registration or mobility registration update procedures) or service request procedures) to indicate/negotiate to/with the network regarding the discontinuous coverage period or UE (100) out-of-coverage period or UE (100) unavailability period (for e.g., duration 2 hours) when the UE (100) is about to lose coverage due to discontinuous coverage or before the UE (100) enters the discontinuous coverage.

The network (for e.g., AMF entity (300)) may configure/adjust the periodic registration timer and/or the implicit deregistration timer to be greater than 2 hours i.e., 2.5 hours or any value (i.e., the discontinuous coverage period or the duration of the UE (100) out-of-coverage period/UE (100) expected unavailability duration (as determined/indicated by the AMF entity (300) or indicated by the UE (100) or negotiated between UE (100) and the AMF entity (300)/Any network Function or based on the satellite coverage availability information or by any method or parameter)) to avoid unintended implicit detach due to coverage gap. For example, the network may run/re-start an implicit deregistration timer for the UE (100) from 10.30 am with a duration of 2.5 hours (10.30 am-1 pm). Since the UE (100) enters discontinuous coverage and the network is aware that UE (100) has entered discontinuous coverage, the network does not implicitly deregister/detach the UE (100). The UE (100) can trigger mobility registration update or any AS/NAS signalling message once UE (100) returns to coverage back from discontinuous coverage.

In an another embodiment, the network (for e.g., the AMF entity (300)) can adjust the mobility management back-off timer (MM BO timer) (for e.g., timer T3346) such that the UE (100) is allowed to trigger any AS/NAS signalling message (for e.g., registration request message for initial registration/mobility registration update or service request message) to indicate/negotiate that to indicate/negotiate to/with the network regarding the discontinuous coverage period or UE (100) out-of-coverage period or UE (100) unavailability period when the UE (100) is about to lose coverage due to discontinuous coverage or before the UE (100) enters the discontinuous coverage. For example If UE (100) gets MM BO timer of value 1 hr and UE (100) is about to enter discontinuous coverage after 30 mins, then the MM BO timer can be adjusted by the network (for e.g., the AMF entity (300)) to be less than 30 mins so that the UE (100) can indicate/negotiate to/to/with the network regarding the discontinuous coverage period or UE (100) out-of-coverage period or UE (100) unavailability period when the UE (100) is about to lose coverage due to discontinuous coverage or before the UE (100) enters the discontinuous coverage.

In an embodiment, the UE (100) may trigger a normal (i.e., not for discontinuous coverage support/coverage indication) initial registration/mobility registration update procedure. If the network (for e.g., AMF entity (300)) detects 5GMM signalling congestion, the AMF entity (300) may reject 5GMM signalling requests (for e.g., registration request messages or service request messages) from the UE (100) and may include/configure/adjust a mobility management back-off timer (For example, timer T3346) with a value to avoid unintended implicit detach of the UE (100) due to coverage gap. The network may decide the value of mobility management back-off timer (For e.g., timer T3346) and/or the periodic registration timer and/or the implicit deregistration timer based on the discontinuous coverage period or the duration of the UE (100) out-of-coverage period/UE (100) expected unavailability duration (as determined/indicated by the AMF entity (300) or indicated by the UE (100) or negotiated between UE (100) and the AMF entity (300)/any network Function or based on the satellite coverage availability information or by any method or parameter).

In an another embodiment, when the UE (100) triggers an initial registration/mobility registration update procedure/service request procedure or any AS/NAS signalling procedure with an indication of “discontinuous coverage support” or any indication to indicate the discontinuous coverage period or UE (100) out-of-coverage period or UE (100) unavailability period and If the network (for e.g., AMF entity (300)) detects 5GMM signalling congestion, the AMF entity (300) does not reject 5GMM signalling requests (for e.g., registration request messages or service request messages) from the UE (100) and optionally, does not include any mobility management back-off timer (MM BO timer) (for e.g., timer T3346) i.e., the network (AMF entity (300) or SMF entity or any network Function) does consider that the NAS MM/SM message is exempted from NAS congestion control.

In an embodiment, the AMF entity (300) may detect 5GMM signalling congestion and perform general NAS level congestion control. Under the 5GMM signalling congestion conditions the AMF entity (300) may reject 5GMM signalling requests from the UE (100)(s). The AMF entity (300) may not reject requests for initial registration or mobility and periodic registration update or service request message, when “discontinuous coverage support” or any indication to indicate the discontinuous coverage period or UE (100) out-of-coverage period or UE (100) unavailability period (unavailability information) is indicated by the UE (100).

In an embodiment, if the UE (100) triggers an initial registration/mobility registration update procedure/service request procedure or any AS/NAS signalling procedure with an indication of “discontinuous coverage support” or any indication to indicate the discontinuous coverage period or UE (100) out-of-coverage period or UE (100) unavailability period and when the network (for e.g., AMF entity (300)) detects 5GMM signalling congestion, the AMF entity (300) may reject 5GMM signalling requests (for e.g., registration request messages or service request messages) from the UE (100) and may include/configure/adjust a mobility management back-off timer (For e.g., timer T3346) with a value to avoid unintended implicit detach of the UE (100) due to coverage gap. The network may decide the value of mobility management back-off timer (For e.g., timer T3346) and/or the periodic registration timer and/or the implicit deregistration timer based on the discontinuous coverage period or the duration of the UE (100) out-of-coverage period/UE (100) expected unavailability duration (as determined/indicated by the AMF entity (300) or indicated by the UE (100) or negotiated between UE (100) and the AMF entity (300)/any network Function or based on the satellite coverage availability information or by any method or parameter).

Embodiments herein disclose methods and systems for handling start time in satellite communications. Embodiments herein disclose methods and systems for handling start time in satellite communications, wherein the UE (100) can update/indicate the start time and unavailability period at the AMF entity (300)/network. Embodiments herein disclose methods and systems for handling start time in satellite communications, wherein the AMF entity (300)/network behaviour is defined, when any subsequent mobility registration update or any other NAS procedure with or without start time and unavailability period information is received.

After indicating the start time, optionally unavailability duration, Situation has changed on the UE (100) side.

The UE (100) mandatorily indicates a new start time and new unavailability period (optionally) with any subsequent NAS message like mobility registration update. Even If there is no change in the absolute start time or unavailability period, the UE (100) sends the old values again or the updated values with the new reference when the NAS message is sent. Upon receiving a message from the UE (100), the AMF entity (300)/network updates the start time and unavailability period (in general the unavailability information) in the UE context with the updated or indicated value. If the start time is determined by relative calculation; for e.g., the time when the AMF entity (300) receives the start time as part of the NAS message or when the UE (100) enters an IDLE state/an INACTIVE state after RRC connection release procedure. Then it is mandatory for the UE (100) to include the start time in every subsequent NAS procedure; e.g., registration procedure before the UE (100) enters discontinuous coverage which is responsible to indicate start time even if the UE (100) triggers the respective registration procedure due to other reasons as listed in TS 24.501.

If the UE (100) wants to remove the start time, the UE indicates to the network by not including the IE in the NAS message or the UE can indicate in an IE; for example, value of Start time in the NAS message can be set like “not defined” or 0000 to indicate removal of start time. Based on this, the AMF entity (300)/network removes/delete the start time from the UE context.

The UE (100) may also not include the unavailability period to remove the unavailability period earlier reported to the network, or the UE may indicate in an IE; for example, value of unavailability period in the NAS message can be set like “not defined” or 0000 to indicate removal of unavailability period. Based on this, the AMF entity (300)/network removes/deletes the unavailability period from the UE context. Since the unavailability period is removed, the associated start time with the unavailability period is removed from the UE context.

Alternatively, if the UE (100) does not include the start time and/or unavailability period from the subsequent NAS message, the AMF entity (300) continue to use the old start time and unavailability period values.

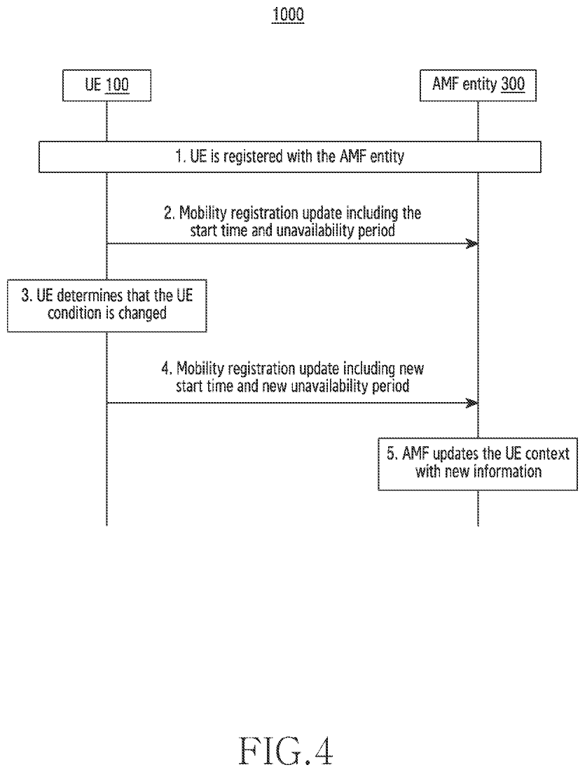

FIG. 4 illustrates an example scenario, wherein the UE (100) indicates a Start time as 10:00 UTC in registration request message to the AMF entity (300) in accordance with some embodiments of the present disclosure.

At step 1, the UE (100) is registered with the AMF entity (300). At step 2, the UE (100) sends the mobility registration update including the start time and unavailability period to the AMF entity (300). At step 3, the UE (100) determines that the UE (100) condition is changed. At step 4, the UE (100) sends the mobility registration update including new start time and new unavailability period to the AMF entity (300). At step 5, the AMF entity (300) updates the UE context with new information.

In an example (as illustrated in FIG. 4), the UE (100) indicates a Start time as 10:00 UTC in registration request message to the AMF entity (300), the UE stores the start time as 10:00 UTC in the UE context. The UE (100) starts a service request procedure without indication start time. There is no impact to the Start time at the AMF entity (300). The UE (100) (due to some other existing triggers as described in TS 24.501) starts a registration procedure. Then, the UE (100) may:
include start time again as 10:00 UTC, in the case AMF entity (300) updates the start time value to 10:00 UTC in the UE context.

does not indicate any start time value. AMF entity (300) continue to keep the start time value as 10:00 UTC in the UE context.

In yet another embodiment, because the UE (100) has not indicated start time, the AMF entity (300) deletes/removes the start time information from the UE context.

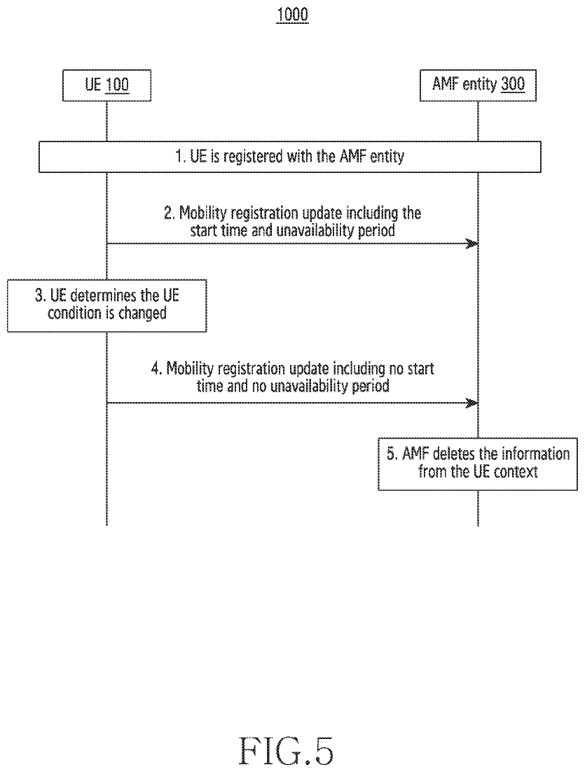

FIG. 5 illustrates an example scenario, wherein the UE (100) mandatorily includes the start time in every registration procedure, and the AMF entity (300) removes the start time, if the AMF entity does not receive the start time in accordance with some embodiments of the present disclosure.

At step 1, the UE (100) is registered with the AMF entity (300). At step 2, the UE (100) sends the mobility registration update including the start time and unavailability period to the AMF entity (300). At step 3, the UE (100) determines the UE (100) condition is changed. At step 4, the UE (100) sends the mobility registration update including no start time and no unavailability period. At step 5, the AMF deletes the information from the UE context.

In another example (as illustrated in FIG. 5), the UE (100) mandatorily includes the start time in every registration procedure, and the AMF entity (300) removes the start time, if the UE does not receive the start time. The UE (100) indicates the Start time as 60 minutes in registration request message to the AMF entity (300), the UE stores the start time as 60 minutes to enter DC in the UE context. Starts the timer with value 60 minutes. 60 minutes can be a reference from the time, the AMF entity (300) received the unavailability period in the NAS message or when the UE (100) is released to an IDLE state or the timer can have any other reference. The UE (100) starts a service request procedure without indicating the start time. Optionally, there is no impact to Start time at the AMF entity (300) because service request message does not have the capability to include start time. The UE (100) (due to some other existing triggers as described in TS 24.501) starts a registration procedure. Then, the UE (100) includes the start time if the UE wants to continue to indicate the start time with the new value as duration 60 minutes-x, where “x” is the duration elapsed for last indication of the start time. In this case, the AMF entity (300) updates the start time value with new value received in the UE context, and starts or restarts the timer again with the new value. If the UE (100) has not indicated start time, the AMF entity (300) deletes/removes the start time information from the UE context and stop the start timer if any running.

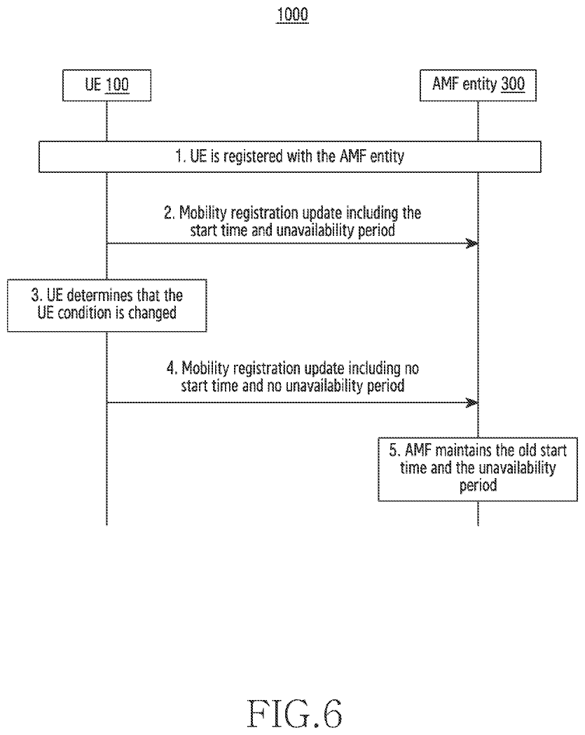

FIG. 6 illustrates an example scenario, wherein the UE (100) may not indicate in subsequent registration procedure, the AMF entity (300) continues to use the old received value, unless explicitly indicated by the UE (100) (if the start time may be removed) according to embodiments of the present disclosure.

At step 1, the UE (100) is registered with the AMF entity (300). At step 2, the UE (100) sends the mobility registration update including the start time and unavailability period. At step 3, the UE (100) determines that the UE (100) condition is changed. At step 4, the UE (100) sends the mobility registration update including no start time and no unavailability period to the AMF entity (300). At step 5, the AMF entity (300) maintains the old start time and the unavailability period.

In another example (as illustrated in FIG. 6), the UE (100) may not indicate in subsequent registration procedure, the AMF entity (300) continues to use the old received value, unless an explicit indication is received from the UE (100) (if the start time may be removed). The UE (100) (due to some other existing triggers as described in TS 24.501) starts a registration procedure. Then, the UE (100) may not include the start time, even if the UE wants to continue to indicate the start time. In this case, the AMF entity (300) continues to run the start timer and maintain the start time indicated by the UE (100) in the last indication using NAS message. If the UE (100) wants to delete at least one of the start time and unavailability period or remove at least one of the start time and unavailability period from UE context at the AMF entity (300), then the UE (100) may indicate in an IE (for example, value of unavailability period/start time in the NAS message can be set like “not defined” or 0000 or any value or the value can be any new or existing IE to indicate removal of at least one of the start time and unavailability period). Based on this, the AMF entity (300)/network removes/delete at least one of the start time and unavailability period from the UE context. If the unavailability period is removed, the associated start time with the unavailability period is removed from the UE context and associated timer is stopped. The UE (100) triggers registration procedure and indicates start time as 60 minutes in registration request message.

The UE (100) faces an abnormal case (for any reasons described in TS 24.501); for example, timer T3510 is expired. Then, the UE (100) starts T3511 timer which is for duration 15 seconds. Thus, the UE (100) ends up utilizing 25 seconds to execute the procedure. Then, the UE (100) restarts the registration procedure; but so far in the prior art, the UE (100) attempts to send the same registration request message with no change in its contents. Now, if the UE (100) indicates 60 minutes as start time, then it may be wrong because the UE (100) has already spent 25 seconds attempting to send a registration request message. Thus, in the next attempt, the UE (100) re-evaluates the start time value; for example, in this case 59 min 35 seconds and indicate the updated start time value to the network. In summary, the UE (100) re-evaluates the start time/unavailability period value in each attempt of registration request message or the NAS message which is responsible of indicating the start time/unavailability period duration. The UE (100) is allowed to trigger the NAS procedure to indicate at least one of the start time and unavailability period duration to the network even if the back-off timer is running. The back-off timer can be at least one of the MMBack-off timer (T3346) or service gap timer (T3447) or control plane data back off timer (T3448).

When the UE (100) indicates a start time or unavailability period duration in the NAS message, then the network may not provide reject message to the UE (100) or not indicate a back off timer. The network considers at least one of the start time and unavailability duration to determine the back-off timer for the UE (100). So that the UE context is maintained. That is, back-off timer may be at least unavailability duration or unavailability duration+start time. For example, the back-off timer can be sufficiently large to cover the discontinuous coverage period to avoid a situation in which back-off timer expires, but the UE (100) is in discontinuous coverage; hence the UE cannot update to the network and the UE context at network is lost or the UE can have a less value; such that on expiry, if the UE (100) has not yet entered discontinuous coverage and the UE (100) has the opportunity to indicate at least one of the start time and unavailability period duration to the network, so that the UE context is maintained. The UE context is maintained by setting appropriate a periodic registration timer, an implicit deregistration timer and mobile reachability timer values. When the start time for unavailability period reaches (i.e., the start timer at the AMF entity (300) expires), then the AMF entity (300) considers that the UE (100) has entered discontinuous coverage. If the UE (100) is in an RRC CONNECTED state or a 5GMM CONNECTED state, the AMF entity (300) releases the RRC Connection of the UE (100) and move the UE (100) to the RRC IDLE state/the RRC inactive state.

The AMF entity (300) triggers the procedure by giving sufficient to complete the procedure before UE (100) enters discontinuous coverage. The AMF entity (300) may not page the UE (100), until the unavailability period duration is completed or the AMF entity (300) determines the end of discontinuous coverage; for example, until the UE (100) enters a CM-CONNECTED state.

The AMF entity (300) triggers the procedure by giving sufficient time to complete the procedure before the UE (100) enters discontinuous coverage; i.e., the AMF entity (300) sets the start time value such that the AMF gets sufficient time to complete the pending procedures to release the UE (100) resources.

For example, the UE (100) indicates the start time as 60 minutes. The AMF entity (300) determines that the AMF takes 1 minute to complete the RRC connection release procedure, then the AMF entity (300) starts the timer with the value 60−1=59 minutes. At the expiry of the timer, the AMF entity (300) releases the UE (100) to an IDLE state.

When the UE (100) determines that the start time indicates to the network is expired, the UE (100) can start timer T3540 waiting for the network to release the NAS signalling connection, if the UE (100) is in the connected state. The UE (100) may not trigger any NAS signalling procedure after the start timer has expired.

The registration procedure (i.e., mobility registration update) is an example, but it can be any NAS message (of EPS or 5GS) which can include or indicate at least one of the unavailability information, start time and unavailability duration. The network behaviour described in this embodiment is applicable.

The purpose of the unavailability information element is to provide the unavailability type, unavailability period duration(also indicate whether the period is present or not present to network) and the start of unavailability period (also indicate whether the period is present or not present to the network) from the UE to the network. The unavailability type indicates whether the unavailability is due to discontinuous coverage or UE reasons.

In this embodiment, the unavailability information, unavailability duration, start of unavailability, out of coverage period are used they are used interchangeably and have same meaning.

In this embodiment, the UE is allowed to trigger registration procedure by sending registration request message(or mobility registration update) to network if the UE includes the unavailability information due to discontinuous coverage, but the UE may not trigger a registration procedure by sending registration request message(or mobility registration update) to network if the UE includes the unavailability information due to UE reasons(i.e., not due to discontinuous coverage in this release). The UE may respect the MM back-off timer and may not trigger any NAS signalling to indicate unavailability information due to UE reasons.

In this embodiment, When NAS level congestion control is active on the network side (AMF or the MME), the AMF does not reject(i.e., accept it) registration procedure by accepting registration request message(or mobility registration update) if the AMF includes the unavailability information due to discontinuous coverage, but the AMF rejects(i.e., does not accept it) registration procedure if the AMF includes the unavailability information due to UE reasons(i.e., not due to discontinuous coverage in this release). The AMF may apply NAS level congestion control for any NAS signalling to indicate unavailability information due to UE reasons by giving reject and include the appropriate back-off timer(e.g., T3346).

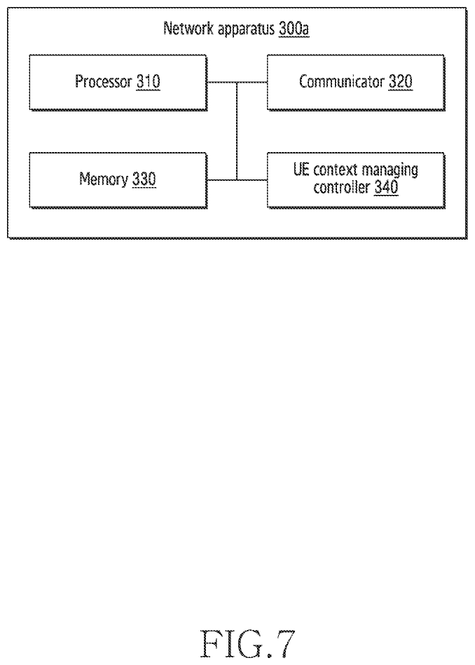

FIG. 7 illustrates various hardware components of the network apparatus (300a) (e.g., AMF entity (300)) according to the embodiments of the present disclosure. In an embodiment, the network apparatus (300a) includes a processor (310), a communicator (320), a memory (330) and a UE context managing controller (340). The processor (310) is coupled with the communicator (320), the memory (330) and the UE context managing controller (340).

In an embodiment, the UE context managing controller (340) detects the 5GMM signalling congestion to perform the NAS level congestion control. Further, the UE context managing controller (340) receives the unavailability information due to discontinuous coverage, when the UE (100) is allowed to initiate a 5GMM procedure. The UE (100) can be, for example, but not limited to a laptop, a smart phone, a desktop computer, a notebook, a device-to-device (D2D) device, a vehicle to everything (V2X) device, a foldable phone, a smart TV, a tablet, an immersive device, and an internet of things (IOT) device.

Furthermore, the UE context managing controller (340) avoids to reject the request for mobility registration update from the UE (100) to manage a context associated with the UE (100) during a discontinuous coverage scenario, when the network apparatus (300a) receives the unavailability information due to the discontinuous coverage from the UE (100).

In another embodiment, the UE context managing controller (340) receives the mobility registration update (registration request message or tracking area update message) including the new unavailability information from the UE (100), when the UE (100) is registered with the AMF/MME entity (300). Further, the UE context managing controller (340) receives the mobility registration update message when the UE (100) determines that the UE condition is changed. Further, the UE context managing controller (340) determines whether the mobility registration update message includes the new unavailability information. In an embodiment, the context managing controller (340) updates the UE context with the new unavailability information upon determining that the mobility registration update message comprises the new unavailability information. In another embodiment, the UE context managing controller (340) deletes the unavailability information from the UE context upon determining that the mobility registration update message does not comprise the new unavailability information.

The UE context managing controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (310) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (310) may include multiple cores and is configured to execute the instructions stored in the memory (330).

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random access Memory (RAM) or cache).

In an embodiment, the communicator (320) includes an electronic circuit specific to a standard that enables wired or wireless communication. The communicator (320) is configured to communicate internally between internal hardware components of the UE (100) and with external devices via one or more networks.

Although the FIG. 7 illustrates various hardware components of the network apparatus (300a) but it is to be understood that other embodiments are not limited thereon. In other embodiments, the network apparatus (300a) may include less or more number of components. Further, the labels or names of the components are used only for illustrative purpose and does not limit the scope of the disclosure. One or more components can be combined together to perform same or substantially similar function in the network apparatus (300a).

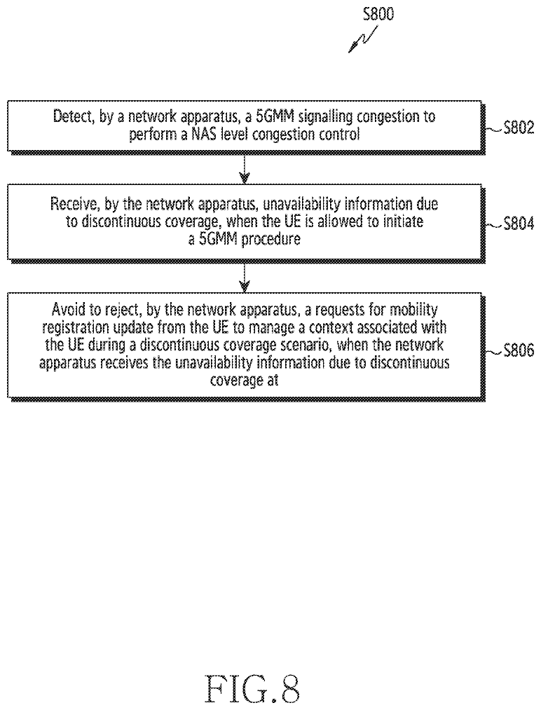

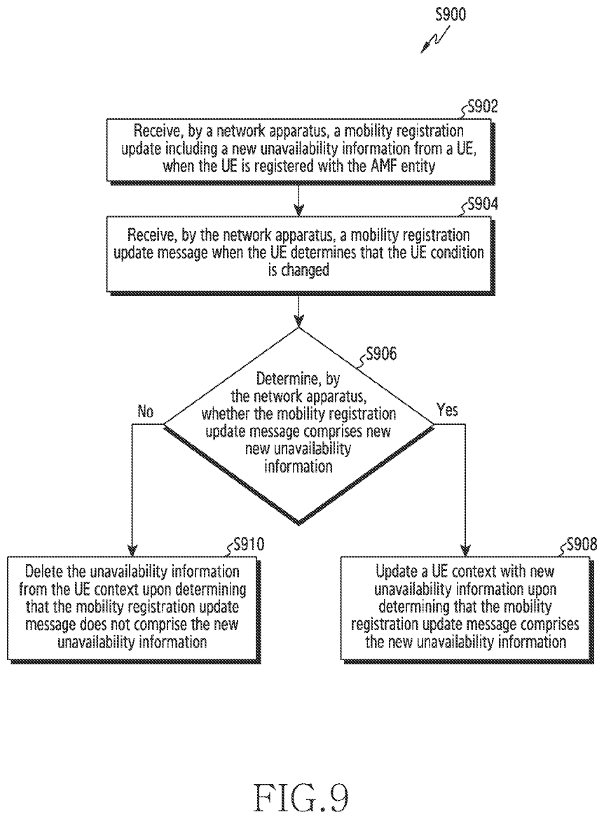

FIG. 8 and FIG. 9 illustrate flowcharts (S1000 and S1100) of a method for managing a context associated with the UE (100) during a discontinuous coverage scenario in the telecommunication network (1000) according to the embodiments of the present disclosure.

As illustrated in FIG. 8, the operations (S802-S806) are handled by the UE context managing controller (340). At S802, the method includes detecting the 5GMM signalling congestion to perform the NAS level congestion control. At S804, the method includes receiving the unavailability information due to discontinuous coverage, when the UE (100) is allowed to initiate a 5GMM procedure. At S806, the method includes avoiding to reject the requests for mobility registration update from the UE (100) to manage a context associated with the UE (100) during a discontinuous coverage scenario, when the network apparatus (300a) receives the unavailability information due to discontinuous coverage from the UE (100).

As illustrated in FIG. 9, the operations (S902-S910) are handled by the UE context managing controller (340). At S902, the method includes receiving the mobility registration update including the new unavailability information from the UE (100), when the UE (100) is registered with the AMF entity (300). At S904, the method includes receiving the mobility registration update message when the UE (100) determines that the UE condition is changed. At S906, the method includes determining whether the mobility registration update message includes the new unavailability information. In an embodiment, At S908, the method includes updating a UE context with the new unavailability information upon determining that the mobility registration update message comprises the new unavailability information. In another embodiment, At S910, the method includes deleting the unavailability information from the UE context upon determining that the mobility registration update message does not comprise the new unavailability information.

The various actions, acts, blocks, steps, or the like in the flow charts (S800-S900) may be performed in the order presented, in a different order or simultaneously. Further, in some embodiments, some of the actions, acts, blocks, steps, or the like may be omitted, added, modified, skipped, or the like without departing from the scope of the disclosure.

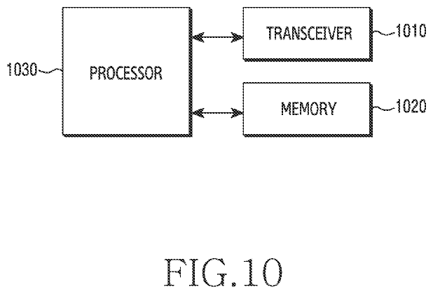

FIG. 10 illustrates a terminal (or a user equipment (UE)), according to embodiments of the present disclosure. FIG. 10 corresponds to the example of the UE (100) of FIG. 1.

As illustrated in FIG. 10, the UE according to an embodiment may include a transceiver 1010, a memory 1020, and a processor 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor.

The transceiver 1010 collectively refers to a UE receiver and a UE transmitter, and may transmit/receive a signal to/from a base station or a network entity. The signal transmitted or received to or from the base station or a network entity may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station or the network entity, and the processor 1030 may determine a result of receiving the control signal and the data signal transmitted by the base station or the network entity.

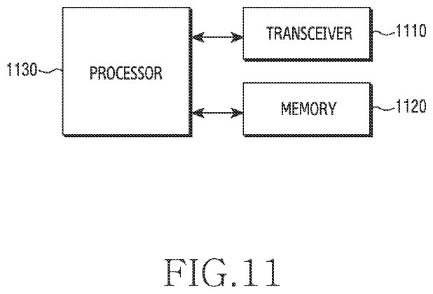

FIG. 11 illustrates a base station according to embodiments of the present disclosure. FIG. 11 corresponds to the example of the gNB of FIG. 1.

As illustrated in FIG. 11, the base station according to an embodiment may include a transceiver 1110, a memory 1120, and a processor 1130. The transceiver 1110, the memory 1120, and the processor 1130 of the base station may operate according to a communication method of the base station described above. However, the components of the base station are not limited thereto. For example, the base station may include more or fewer components than those described above. In addition, the processor 1130, the transceiver 1110, and the memory 1120 may be implemented as a single chip. Also, the processor 1130 may include at least one processor.

The transceiver 1110 collectively refers to a base station receiver and a base station transmitter, and may transmit/receive a signal to/from a terminal or a network entity. The signal transmitted or received to or from the terminal or a network entity may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the base station. Also, the memory 1120 may store control information or data included in a signal obtained by the base station. The memory 1120 may be a storage medium, such as read-only memory (ROM), random access memory (RAM), a hard disk, a CD-ROM, and a DVD, or a combination of storage media.

The processor 1130 may control a series of processes such that the base station operates as described above. For example, the transceiver 1110 may receive a data signal including a control signal transmitted by the terminal, and the processor 1130 may determine a result of receiving the control signal and the data signal transmitted by the terminal.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an access and mobility management function (AMF) entity in a wireless communication system, the method comprising:
receiving, from a user equipment (UE), a registration request message;
transmitting, to the UE, a registration reject message based on a congestion, the registration reject message including information on a back-off timer; and
receiving, from the UE, registration update information related to a discontinuous coverage, while the back-off timer is running.

2. The method of claim 1, wherein the registration update information is based for reporting an unavailability related to the discontinuous coverage.

3. The method of claim 1, wherein the registration reject message further includes a cause value indicating the congestion.

4. The method of claim 1, wherein the registration update information includes a start time of an unavailability period or a duration of the unavailability period associated with the discontinuous coverage, and
wherein the start time is different from a previous start time of the unavailability period, and the duration is different from a previous duration of the unavailability period.

5. The method of claim 4, further comprising:
updating a UE context based on the start time or the duration included in the registration update information.

6. The method of claim 4, further comprising:
discarding the previous start time or the previous duration from a UE context, in case that the registration update information does not include the start time or the duration.

7. A method performed by a user equipment (UE) in a wireless communication system, the method comprising:
transmitting, an access and mobility management function (AMF) entity, a registration request message;
receiving, from the AMF entity, a registration reject message based on a congestion, the registration reject message including information on a back-off timer;
starting the back-off timer based on the registration reject message; and
transmitting, to the AMF entity, registration update information related to a discontinuous coverage, while the back-off timer is running.

8. The method of claim 7, wherein the registration update information is based for reporting an unavailability related to the discontinuous coverage.

9. The method of claim 7, wherein the registration reject message further includes a cause value indicating the congestion.

10. The method of claim 7, wherein the update information includes a start time of an unavailability period or a duration of the unavailability period associated with the discontinuous coverage, and
wherein the start time is different from a previous start time of the unavailability period, and the duration is different from a previous duration of the unavailability period.

11. An access and mobility management function (AMF) entity in a wireless communication system, the AMF entity comprising:
a transceiver; and
a controller coupled with the transceiver and configured to:
receive, from a user equipment (UE), a registration request message,
transmit, to the UE, a registration reject message based on a congestion, the registration reject message including information on a back-off timer, and
receive, from the UE, registration update information related to a discontinuous coverage, while the back-off timer is running.

12. The AMF entity of claim 11, wherein the registration update information is based for reporting an unavailability related to the discontinuous coverage.

13. The AMF entity of claim 11, wherein the registration reject message further includes a cause value indicating the congestion.

14. The AMF entity of claim 11, wherein the registration update information includes a start time of an unavailability period or a duration of the unavailability period associated with the discontinuous coverage, and
wherein the start time is different from a previous start time of the unavailability period, and the duration is different from a previous duration of the unavailability period.

15. The AMF entity of claim 14, wherein the controller further configured to:
update a UE context based on the start time or the duration included in the registration update information.

16. The AMF entity of claim 14, wherein the controller further configured to:
discard the previous start time or the previous duration from a UE context, in case that the registration update information does not include the start time or the duration.

17. A user equipment (UE) in a wireless communication system, the UE comprising:
a transceiver; and
a controller coupled with the transceiver and configured to:
transmit, an access and mobility management function (AMF) entity, a registration request message,
receive, from the AMF entity, a registration reject message based on a congestion, the registration reject message including information on a mobility management (MM) back-off timer,
start the back-off timer based on the registration reject message, and
transmit, to the AMF entity, registration update information related to a discontinuous coverage, while the back-off timer is running.

18. The UE of claim 17, wherein the registration update information is based on for reporting an unavailability related to the discontinuous coverage.

19. The UE of claim 17, wherein the registration reject message includes a cause value indicating the congestion.

20. The UE of claim 17, wherein the registration update information includes a start time of an unavailability period or a duration of the unavailability period associated with the discontinuous coverage, and
wherein the start time is different from a previous start time of the unavailability period, and the duration is different from a previous duration of the unavailability period.
